(19) United States
(12) Patent Application Publication
(10) Pub. No.: US 2003/0117668 A1
(43) Pub. Date: Jun. 26, 2003

(54) Facsimile apparatus and electronic equipment

(75) Inventor: Yoshihisa Takeuchi, Joyo-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/322,401

(22) Filed: Dec. 18, 2002

(30) Foreign Application Priority Data
Dec. 25, 2001 (JP) 2001-391578

(51) Int. Cl. H04N 1/38; H04N 1/46

(52) U.S. Cl. 358/463; 358/500

(57) ABSTRACT

A facsimile apparatus includes at least one main control circuit is provided in each module, and a control circuit in each module controls the circuit elements in the module.

### BACKGROUND OF THE INVENTION

1. Field of the Invention

The present invention relates to a facsimile apparatus, in which the emissions of high frequency electromagnetic noise can be reduced when the processing speed of a CPU (Central Processing Unit) in each main control circuit is reduced. The load of the respective main control circuits can be reduced as circuit elements in the facsimile apparatus. The facsimile apparatus is divided into a plurality of modules and controlled by the main control circuit in the respective modules.

2. Description of the Related Art

FIG. 2 is a block diagram showing circuit elements of a conventional facsimile apparatus 51. As illustrated in FIG. 2, the conventional facsimile apparatus 51 includes a central processing unit (CPU) 54, and a lot of circuit elements, such as a program memory, a RAM (Random Access Memory), a MODEM, a CODEC, a scanner ASIC (ASIC: Application Specific Integrated Circuit), a scanner print CODEC, a memory ASIC, a print ASIC, and a display control ASIC, so as to transmit and receive signals through a main bus 53 on a base plate 52. Moreover, controlled equipment such as a liquid crystal display, a printer interface, a network control unit (NCU), an automatic document feeder (ADF), a scanner, and a printer is connected to the base plate 52 through a signal cable 55 such as 16-bit parallel cable.

In the conventional facsimile apparatus 51, one CPU 54 controls each circuit element and equipment, so that a high frequency clock signal is needed for processing the entire facsimile apparatus 51 at high speeds. Thus, a 32 MHz clock signal is supplied from a reference signal generation circuit 56 to the central processing circuit 54. In this case, the high frequency clock signal is transmitted to the main bus 53 and the signal cable 55.

However, such a high frequency clock signal, transmitted through the main bus 53 and the signal cable 55, causes emissions of electromagnetic noise. In particular, as high frequency electromagnetic noise may cause adverse effects on peripheral circuitry and equipment, electromagnetic noise having a frequency of more than 30 MHz is regulated strictly by the Voluntary Control Council for Interference by Information Technology Equipment (VCCI).

It is a feature of the present invention to provide a facsimile apparatus, in which emissions of the high frequency electromagnetic noise can be reduced without reducing the processing speed of the facsimile apparatus.

### SUMMARY OF THE INVENTION

A facsimile apparatus of the present invention includes a first module having circuit elements for controlling an operation of the entire facsimile apparatus and a second module having circuit elements for controlling a mechanism of the entire facsimile apparatus. At least one main control circuit is provided in each module, and the main control circuit in each module controls circuit elements in the module.

Main control circuits in each module are connected by a serial interface.

Main control circuits in the first module controls main control circuits in the second module.

Equipment connected to the respective modules is controlled by the main control circuit in the module.

Control circuits in each module are formed on one base plate.

The first module includes circuit elements for controlling the transmission and the reception of a facsimile.

A scanner to read image of a document as electronic data is connected to the second module, which has a scanner ASIC controlling an operation of the scanner, and the main control circuit in the second module controls the scanner ASIC.

A printer to print image on a paper is connected to the second module, which has a printer ASIC controlling an operation of the printer, and the main control circuit in the second module controls the printer ASIC.

A memory to store image data is connected to the second module, which controls an operation of the memory and has a memory ASIC, and the main control circuit in the second module controls the memory ASIC.

Moreover, the facsimile apparatus of the present invention includes a display part that displays a condition of the facsimile apparatus and a third module having a display ASIC that controls an operation of the display part. At least one main control circuit is provided in a third module, and the main control circuit controls the display control ASIC.

The main control circuits in the first and third modules are connected by a serial interface.

The main control circuit in the first module controls the main control circuit in the third module.

According to the present invention, the circuit elements in the facsimile apparatus are divided into a plurality of modules and each main control circuit controls the circuit elements in each module, so that the processing load in each control circuit can be reduced. Moreover, the processing speed of the main control circuit in each module can be reduced and the clock signal's frequency supplied to the main control circuit in each module can be lowered, without reducing the processing speed of the facsimile apparatus, compared with the conventional facsimile apparatus having only one high speed control means. Thus, as the clock frequency of control signal transmitted through the bus and cable can also be lowered, the emissions of high frequency electromagnetic noise can be reduced.

Moreover, according to the present invention, each module is mutually connected by a serial interface, so that the number of signal lines in the signal cable connecting modules can be reduced and the emissions of the electromagnetic noise from the signal cable can be reduced, compared with the connection by a parallel interface. Thus, as the volume of control signals, transmitted through the signal cable that connects modules, can be reduced by sharing the load in controlling the operation of the facsimile apparatus in each module, even if the modules are connected by the serial interface, the processing speed of the facsimile apparatus does not change so much.

Furthermore, according to the present invention, as equipment connected to each module is controlled by each main control circuit in each module, the control processing load in each main control circuit can be reduced. The speed of the main control circuit in each module can also be reduced, and the clock signal's frequency supplied to the main control circuit in each module can be lowered. Thus, as the clock frequency of data signals transmitted through the bus and signal cable can be lowered, the emissions of high frequency electromagnetic noise can be reduced even more.

### BRIEF DESCRIPTION OF THE DRAWINGS

FIG. 1 is a block diagram showing a circuit configuration of facsimile apparatus in a preferred embodiment of the present invention.

FIG. 2 is a block diagram showing a circuit configuration of conventional facsimile apparatus.

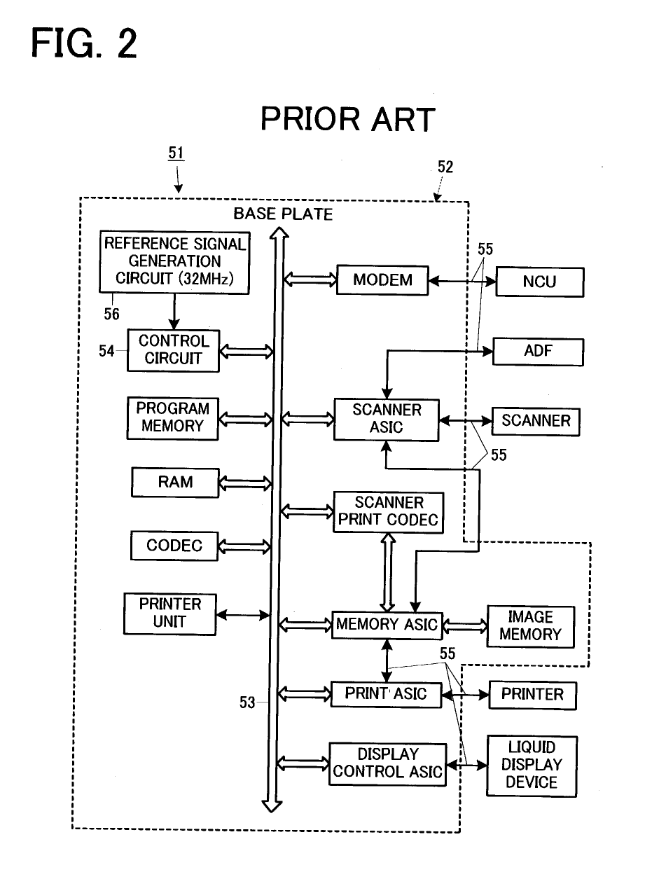

### DETAILED DESCRIPTION OF THE INVENTION

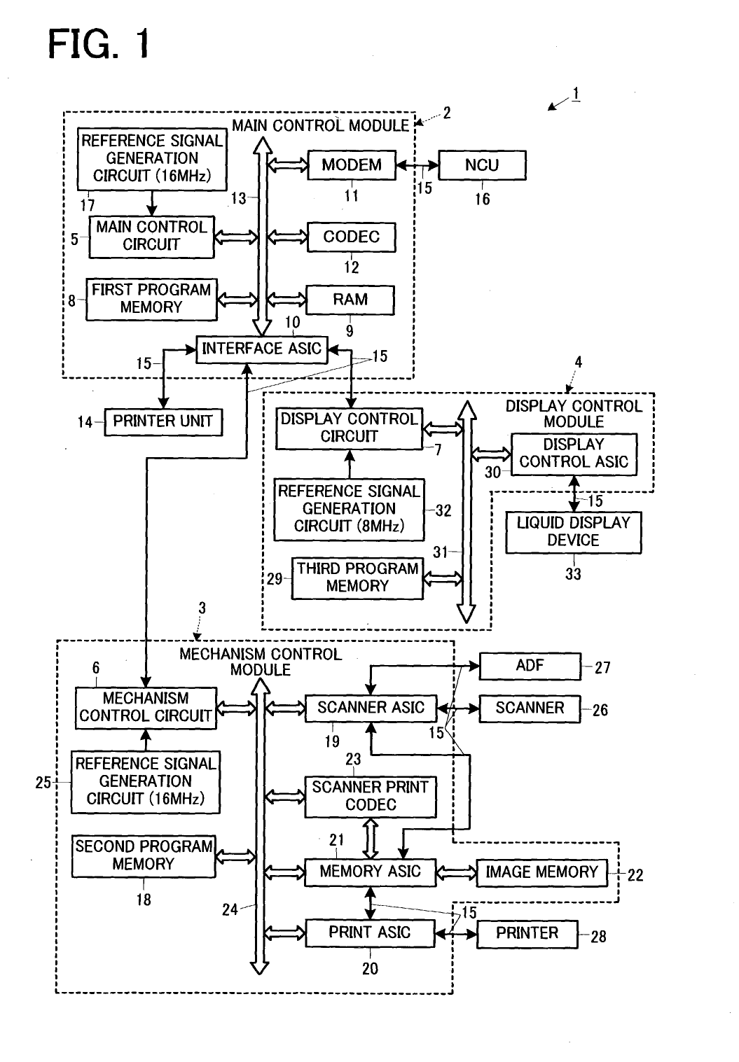

Hereinafter, a facsimile apparatus 1 in a preferred embodiment of the present invention will be described with reference to the drawings. FIG. 1 is a block diagram showing a circuit configuration of the facsimile apparatus 1. Circuit elements in the facsimile apparatus 1 are divided into a plurality of modules. To be more precise, three modules such as a main control module 2, a mechanism control module 3, and a display control module 4. At least one main control circuit, to be more precise, a control circuit 5 for the entire control (a main control circuit 5), a control circuit 6 for mechanism control (a mechanism control circuit 6), or a control circuit 7 for displaying control (a display control circuit 7) is provided in each module. The circuit elements in each module are controlled by the main control circuit in each module. In this embodiment, the respective circuit elements in the main control module 2, the mechanism control module 3, and the display control module 4 are formed on a sheet of a base plate. Hereinafter, the apparatus will be described in greater detail.

The main control module 2 controls the entire operation of the facsimile apparatus 1. That is, the main control module 2 controls the operation of the mechanism control module 3 and the display control module 4, and the transmission and reception of a facsimile.

In this specification, the main control circuit 5 makes the mechanism control circuit 6 control an operation of each part of the mechanism control module 3. Moreover, the main control circuit 5 makes the display control circuit 7 control an operation of each part of the display control module 4. In this embodiment, the main control module 2 includes the main control circuit 5, a first program memory 8, a RAM (Random Access Memory) 9, an interface ASIC (Application Specific Integrated Circuit) 10, a MODEM 11, and a CODEC (Coder and Decoder) 12.

The main control circuit 5 that is a CPU (Central Processing Unit) for processing data controls the operation of each part in the main control module 2, operations of the mechanism control module 3 and the display control module 4, and the transmission and reception of a facsimile. The main control circuit 5 is connected to each part in the main control module 2 through a main control bus 13 so as to transmit signals.

The first program memory 8 stores various programs including operational programs necessary for the control process by the main control circuit 5. The RAM 9 is capable of writing and reading various data temporarily, which is acquired by the control process of the main control circuit 5. The interface ASIC 10 connects the mechanism control circuit 6, the display control circuit 7, and a printer unit 7 with the main control bus 13. In this specification, the printer unit 14, which is controlled equipment connected to the interface ASIC 10, is an optional unit that connects the facsimile apparatus 1 and an appropriate terminal device for using the facsimile apparatus 1 as a printer that is a terminal device such as a personal computer.

The interface ASIC 10 is connected to the mechanism control circuit 6 and to the display control circuit 7 through a signal cable 15 of the serial interface so as to transmit data signals. More precisely, the main control module 2, the mechanism control module 3, and the display control module 4 are connected through the serial interface. When the modules connect by the serial interface, the number of signal lines in the signal cable 15 can be reduced compared with the connection by a parallel interface, and the emissions of electromagnetic noise from the signal cable can be reduced. Moreover, as the volume of control signals transmitted through the signal cable 15 that connect the modules can be reduced by sharing the load in controlling the operation of the facsimile apparatus 1, the processing speed of the facsimile apparatus 1 is not reduced so much. Moreover, in this specification, the interface ASIC 10 is connected to the printer unit 14 through the signal cable 15 of the serial interface.

The MODEM 11 is a unit that converts digital signals into analogue signals when transmitting or receiving facsimile data via the PSTN (Public Switched Telephone Network). A NCU (Network Control Unit) 16, which is controlled equipment connected to the MODEM 11, controls the PSTN. The MODEM 11 is connected to the NCU 16 through the signal cable 15 of the serial interface so as to transmit signals. The CODEC 12 is a circuit that encodes and decodes transmission and reception data in facsimile communication.

In this embodiment, a 16MHz clock signal is transmitted from a reference signal generation circuit 17 to the main control circuit 5. This frequency is lower than the one of the clock signal transmitted to the main control circuit 54 in the conventional facsimile apparatus 51. As the load concerning the main control circuit 5 can be reduced by that the circuit elements in the facsimile apparatus 1 are divided into three modules including the main control module 2, the mechanism control module 3, and the display control module 4, which are respectively controlled by the main control circuit 5, the mechanism control circuit 6, and the display control circuit 7, the clock signal's frequency transmitted to the main control circuit 5 can be reduced. Thus, the clock frequency of the control signal transmitted through the main control bus 13 and the signal cable 15 can be as low as 16 MHz, and the emissions of high frequency electromagnetic noise from the main control bus 13 and the signal cable 15 can be reduced.

The mechanism control module 3 includes the circuit elements for controlling the operation of each mechanism, such as reading images, printing, and storing the images in the facsimile apparatus 1. In this embodiment, the mechanism control module 3 includes the respective circuit elements that are the mechanism control circuit 6, a second program memory 18, a scanner ASIC 19, a print ASIC 20, a memory ASIC 21, an image memory 22, and a scanner print CODEC 23.

The mechanism control circuit 6, which is a CPU for processing data, is a main control circuit equipped with the mechanism control module 3 and controls the operation of each part in the mechanism control module 3. The mechanism control circuit 6 is connected to each part in the mechanism control module through a mechanism control bus 24 so as to transmit signals. In this embodiment, the 16 MHz clock signal is transmitted from the reference signal generation circuit 25 to the mechanism control circuit 6, the same as the case of the main control circuit 5 as described above.

As the load concerning the mechanism control circuit 6 can be reduced by that the circuit elements in the facsimile apparatus 1 are divided into three modules including the main control module 2, the mechanism control module 3, and the display control module 4 and the mechanism control circuit 6 only controls the operation in each mechanism included in the mechanism control module 3, the clock signals' frequency can be lower than that in the conventional facsimile apparatus. Thus, the clock frequency of the signal transmitted through the mechanism control bus 24 and the signal cable 15 can be relatively low, such as 16 MHz, and the emissions of high frequency electromagnetic noise from the mechanism control bus 24 and the signal cable 15 can be reduced.

The second program memory 18 stores various programs such as an operational program necessary for the control process by the mechanism control circuit 6. The scanner ASIC 19 is a circuit for controlling an operation of a scanner 26 and an ADF (Automatic Document Feeder) 27, based on an instruction signal from the mechanism control circuit 6. In this specification, the scanner 26, which is controlled equipment connected to the scanner ASIC 19, is an apparatus for scanning to read an image of a document as electronic data for facsimile transmission. Moreover, the ADF 27, which is controlled equipment connected to the scanner ASIC 19, is an apparatus for feeding,a document to a position read by the scanner 26 automatically. The scanner ASIC 19 is connected to the scanner 26 and to the ADF 27 through the signal cable 15 of the serial interface so as to transmit control signals.

The print ASIC 20 is a circuit for controlling the operation of a printer 28 in a printing mechanism based on an instruction signal from the mechanism control circuit 6. In this specification, the printer 28, which is controlled equipment connected to the print ASIC 20, is a mechanism for printing image data on a document stored in the image memory 22 on a recording sheet. The print ASIC 20 is connected to the printer 28 through the signal cable 15 of the serial interface so as to transmit control signals.

The memory ASIC 21 is a circuit for controlling the image memory 22, based on an instruction signal from the mechanism control circuit 6. The image memory 22 stores image data that is received by facsimile and is taken by reading a document by the scanner 26. The memory ASIC 21 is connected to the scanner ASIC 19 and to the print ASIC 20 through the signal cable 15 of the serial interface so as to transmit signals.

The scanner print CODEC 23 is a circuit for encoding and decoding image data stored in the image memory 22. To be more precise, the scanner print CODEC 23 encodes image data on a document read by the scanner 26 for storing in the image memory 22, or decodes image data of a document stored in the image memory 22 for printing in the printer 28.

The display control module 4 includes the circuit elements for controlling the operation of the display part that displays information such as operational conditions and setting conditions of the facsimile apparatus 1. In this embodiment, the display control module 4 includes the respective circuit elements such as the display control circuit 7, a third program memory 29, and a display control ASIC 30.

The display control circuit 7, which is a CPU equipped with the display control module 4 for processing data, controls the operation of each part in the display control module 4. The display control circuit 7 is connected to each part in the display control module through a display control bus 31 so as to transmit signals. In this embodiment, an 8 MHz clock signal is transmitted from a reference signal generation circuit 32 to the display control circuit 7.

The circuit elements included in the display control module 4 to be controlled by the display control circuit 7 are fewer than the circuit elements to be controlled by the main control circuit 5 and the mechanism control circuit 6. The load concerning the display control circuit 7 can be reduced compared with the one in the main control circuit 5 or the mechanism control circuit 6. Thus, the frequency can be much lower than the clock signal's frequency transmitted to the main control circuit 5 and the mechanism control circuit 6.

The third program memory 29 stores various programs such as an operational program necessary for the control process by the display control circuit 7. The display control ASIC 30 is a circuit for controlling the operation of a liquid crystal display device 33 included in the display part, based on an instruction signal from the display control circuit 7. In this specification, the liquid crystal display device 33, which is controlled equipment connected to the display control ASIC 30, displays information such as given letters and figures on a liquid display screen and also displays information such as operational conditions and setting conditions of the facsimile apparatus 1. The display control ASIC 30 is connected to the liquid display device 33 through the signal cable 15 of the serial interface so as to transmit signals.

As described above, the modules are connected by the signal cable 15 of the serial interface. More precisely, the main control module 2 is connected to the mechanism control module 3 and to the display control module 4 through the signal cable 15 of the serial interface. Moreover, each module is connected to controlled equipment through the signal cable 15 of the serial interface. More precisely, the interface ASIC 10 is connected to the printer unit 14, and the scanner ASIC 19 is connected to the scanner 26 and to the ADF 27, through the signal cable 15 of the serial interface. However, these connections are not limited to the serial interface, and other interfaces are also available. For example, a fiber optic cable is suitable for transmitting light signals, as the electromagnetic noise is not generated from the fiber optic cable. Alternatively, the connection, which uses the method of transmitting differential signals whose volume is equal to the two signal lines and whose phase is reversed, is suitable since the electromagnetic noise can be offset by the magnetic fields generated by the two signal lines affecting one another, and the volume of the electromagnetic noise generated from the signal lines can be reduced even more.

What is claimed is:

1. A facsimile apparatus, comprising
circuit elements divided among a plurality of modules;
at least one main control circuit provided in each module; and
the main control circuit in each module controls the circuit elements in the module.

2. The facsimile apparatus as in claim 1, wherein the main control circuit in each module is connected by a serial interface.

3. The facsimile apparatus as in claim 1, wherein equipment connected to each module is controlled by the main control circuit in the module.

4. The facsimile apparatus as in claim 1, wherein the circuit elements in each module are formed on one base plate.

5. A facsimile apparatus comprising:
a first module having circuit elements for controlling an operation of a facsimile apparatus; and
a second module having circuit elements for controlling another operation of the facsimile apparatus,
wherein at least one control circuit is provided in each module, and the control circuit in each module controls the circuit elements of the module.

6. The facsimile apparatus as in claim 5, wherein control circuits in each module are connected by a serial interface.

7. The facsimile apparatus as in claim 5, wherein the control circuit in the first module controls the control circuit in the second module.

8. The facsimile apparatus as in claim 5, wherein equipment connected to each module is controlled by the control circuit in the module.

9. The facsimile apparatus as in claim 5, wherein circuit elements in each module are formed on one base plate.

10. The facsimile apparatus as in claim 5, wherein the first module includes circuit elements for controlling the transmission and reception of a facsimile.

11. The facsimile apparatus as in claim 8, wherein a scanner is connected to the second module, having a scanner ASIC controlling an operation of the scanner, and the control circuit in the second module controls the scanner ASIC.

12. The facsimile apparatus as in claim 8, wherein a printer is connected to the second module, having a printer ASIC controlling an operation of the printer, and the control circuit in the second module controls the printer ASIC.

13. The facsimile apparatus as in claim 8, wherein a memory is connected to the second module, and has a memory ASIC, and the control circuit in the second module controls the memory ASIC.

14. The facsimile apparatus as in claim 5 further, comprising:
a display part that displays a condition of the facsimile apparatus; and
a third module having a display control ASIC that controls an operation of the display part,
wherein at least one control circuit is provided in the third module, and the control circuit in the third module controls the display control ASIC.

15. The facsimile apparatus as in claim 14, wherein the control circuits in the first and third modules are connected by a serial interface.

16. The facsimile apparatus as in claim 14, wherein the control circuit in the first module controls the control circuit in the third module.

17. Electronic equipment comprising:
circuit elements divided among a plurality of modules; and
at least one control circuit provided in each modules, wherein the control circuit in each module controls circuit elements in the module.

18. The electronic equipment as in claim 17, wherein control circuits in each module are connected by a serial interface.

19. The electronic equipment as in claim 17, wherein equipment connected to each module is controlled by the control circuit in the module.

20. The electronic equipment as in claim 17, wherein circuit elements in each module are formed on one base plate.
